(19) United States
(12) Patent Application Publication
(10) Pub. No.: US 2025/0076588 A1
(43) Pub. Date: Mar. 6, 2025

(54) PUSH-BUTTON ACTUATOR USED IN FIBER OPTIC TERMINALS HAVING AN OPTICAL CONNECTION PORT

(71) Applicant: CORNING RESEARCH & DEVELOPMENT CORPORATION, CORNING, NY (US)

(72) Inventor: Joel Christopher Rosson, Hickory, NC (US)

(21) Appl. No.: 18/818,359

(22) Filed: Aug. 28, 2024

Related U.S. Application Data
(60) Provisional application No. 63/535,940, filed on Aug. 31, 2023.

(51) Int. Cl. G02B 6/38

(52) U.S. Cl. CPC G02B 6/3831

(57) ABSTRACT

Improved push-button actuator comprising a first piece and a second piece for use with fiber optic terminals having a connection port for receiving an external fiber optic connector for optical mating. The push-button is used for releasing an external fiber optic connector from the connection port of the fiber optic terminal. The push-button actuator may have a seal sized for fitting about the first piece for keeping dirt, dust or debris out of the fiber optic terminal. Fiber optic terminals using the push-button may comprise a shell, at least one connection port disposed on the terminal, and at least one securing feature associated with the connection port that may be actuated by the push-button for releasing an external fiber optic from the connection port as desired. Additionally, the at least one securing feature of the terminal may be biased by a resilient member to a normally retained position if desired.

### RELATED PRIORITY APPLICATIONS

This application claims the benefit of priority of U.S. Provisional Application Ser. No. 63/535,940 filed on Aug. 31, 2023, the content of which is relied upon and incorporated herein by reference in its entirety.

### FIELD

Push-button actuators useful in fiber optic terminals having one or more connection ports for receiving respective external fiber optical connectors and making respective optical connections are disclosed. More specifically, improved push-button actuator comprising a first piece and a second piece that are useful in fiber optic terminals for releasing a respective external fiber optic connector from the respective connection port are disclosed.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent. To address this need for making quick, reliable, and robust optical connections in communication networks hardened fiber optic connectors such as the OptiTap® plug connector were developed that attach use a threaded coupling nut for optical connectivity and Pushlok™ connectors having a push and click features for quick optical connectivity. Fiber optic terminals also known as multiports were also developed for making an optical connections with hardened connectors such as the OptiTap® or Pushlok™ connectors.

Fiber optic terminals are used for making optical connections in fiber optic networks and typically receive external fiber optic connectors that may be mated and unmated with fiber optic terminal for providing the network operator flexibility in building and servicing optical networks. The fiber optic terminal receives one or more input optical fibers into its housing and distributes respective optical fibers to the connection ports of the fiber optic terminal so that external fiber optic connectors may be optically connected to the fiber optic terminal for the optical network. By way of further explanation, the connection ports allow the optical mating with external fiber optic connectors that may be attached to drop or branching cables such as drop cables for “fiber-to-the-home” applications or the like. Further, fiber optic terminals advantageously allow network operators to delay optically connecting drop or branching cables until needed, thereby delaying capital expenses until service is required. Thus, fiber optic terminals allowed quick and easy deployment for optical networks.

Evolv® fiber optic terminals with Pushlok™ technology are used for making optical connections with Pushlok™ connectors both available from Corning Optical Communications, LLC of Charlotte, North Carolina and use one or more push-button for releasing external fiber optic connectors from the respective connection port of the fiber optic terminal. Evolv® fiber optic terminals use a push-button configured as a single molded component with an O-ring on the body of the push-button for sealing the moving push-button with the shell of the fiber optic terminal.

There exists a need for fiber optic terminals that allow flexibility for the network operators to quickly and easily make optical connections in optical networks while also providing improved reliability, sealing, and/or manufacturing for the fiber optic terminals.

### SUMMARY

The disclosure is directed to improved push-button actuators comprising a first piece and a second piece for use with fiber optic terminals having a connection port capable of receiving an external fiber optic connector for optical mating. The push-buttons disclosed are used for releasing an external fiber optic connector from the connection port of the fiber optic terminal. The fiber optic terminals or the like that may use the push-button actuators disclosed herein comprise at least one connection port and a securing feature associated with the connection port. Devices that may use the push-button actuator concepts disclosed herein include terminals, multiports, closures or wireless devices. The devices using the push-button actuators can have any suitable construction such as disclosed herein such a connection port that is keyed for inhibiting a non-compliant connector from being inserted and potentially causing damage to the device.

The disclosure is directed to push-button actuators used for releasing external fiber optic connectors from respective connection ports of a fiber optic terminal or the like. The push-button actuator comprises a first piece and a second piece that cooperates with the first piece. The first piece has a first diameter and a second diameter with the first diameter being larger than the second diameter, and the second piece is configured as an annular ring that cooperates with the first piece. A seal may be fitted about the second diameter of the first piece for sealing between the push-button actuator and the shell of the terminal. Using a two-piece construction allows the surface of the push-button actuator that receives the seal to avoid being located on or near a molding part line and have more consistency in the surface finish and dimension for providing improved sealing characteristics.

Another aspect of the disclosure is directed to push-button actuators used for releasing external fiber optic connectors from respective connection ports of a fiber optic terminal or the like. The push-button actuator comprises a first piece and a second piece that cooperates with the first piece. The first piece has a first diameter and a second diameter with the first diameter being larger than the second diameter along with a finger protruding from a first side. The second piece is configured as an annular ring that cooperates with the first piece, and the second piece is welded to the first piece. A seal may be fitted about the second diameter of the first piece for sealing between the push-button actuator and the shell of the terminal. The surface of the push-button actuator used for receiving the seal can avoid being located on or near a molding part line and have more consistency in the surface finish and dimension for providing improved sealing characteristics.

A further aspect of the disclosure is directed to a fiber optic terminal for making an optical connection with one or more external fiber optic connectors. The fiber optic terminal comprising a shell, at least one connection port disposed on the fiber optic terminal, and at least one securing feature, at least one securing feature resilient member, and a push-button actuator. The at least one connection port comprises an optical connector opening extending from an outer surface of the fiber optic terminal to a cavity of the fiber optic terminal and defining a connection port passageway. The at least one securing feature is associated with the connection port passageway, and at least one securing feature resilient member for biasing a portion of the at least one securing feature. The push-button actuator cooperates with the at least one securing feature, and the push-button actuator comprises a first piece and a second piece that cooperates with the first piece. The first piece has a first diameter and a second diameter with the first diameter being larger than the second diameter, and the second piece is configured as an annular ring that cooperates with the first piece. A seal may be fitted about the second diameter of the first piece for sealing between the push-button actuator and the shell of the terminal.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the concepts and are incorporated into and constitute a part of this specification. The drawings illustrate various embodiments and together with the description serve to explain the principles and operation.

### BRIEF DESCRIPTION OF THE FIGURES

FIGS. 1 and 2 respectively are top and bottom perspectives view of an explanatory fiber optic terminal using push-button actuators for releasing external fiber optic connectors that may be attached to the fiber optic terminal for making optical connection with the device;

FIG. 3 depicts a longitudinal sectional view of the fiber optic terminal of FIGS. 1 and 2 through the connection port for showing the internal construction of the fiber optic terminal with the rear (internal) connector shown and the optical fibers removed for clarity;

FIG. 4 is a partially exploded view of the fiber optic terminal of FIGS. 1 and 2 with the optical fiber assembly comprising an optical splitter;

FIGS. 5 and 6 respectively are assembled front and rear perspective views of the modular adapter sub-assembly that cooperates with a respective connection port of the fiber optic terminal of FIGS. 1 and 2 for optical mating with the rear connector attached to the modular adapter sub-assembly;

FIG. 7 is an exploded view of the modular adapter sub-assembly of FIGS. 5 and 6 along with the rear connector;

FIG. 8 is a longitudinal sectional view of the modular adapter sub-assembly of FIGS. 5 and 6 with the rear connector attached;

FIGS. 9 and 10 are top perspective views from different directions of a second portion of the shell of the fiber optic terminal of FIGS. 1 and 2;

FIG. 11 is a top perspective view of the modular adapter sub-assemblies loaded into the second portion of the shell with the optical fibers removed for clarity;

FIG. 12 is an inside perspective view of the first portion of the shell;

FIGS. 13A-13C depict perspective views showing the details of a first embodiment of a two-piece push-button actuator for use with the fiber optic terminal of FIGS. 1 and 2 that cooperates with the securing member of FIGS. 15-17;

FIGS. 14A and 14B depict perspective views showing the details of a second embodiment of a two-piece push-button actuator for use with the fiber optic terminal of FIGS. 1 and 2 that cooperates with the securing member of FIGS. 15-17;

FIGS. 15-17 are various perspective views showing the details of the securing member of the securing feature of the fiber optic terminal of FIGS. 1 and 2 that may cooperate with the two-piece actuator of FIGS. 13A-C or FIGS. 14A and 14B;

FIG. 18-21 are various perspective views showing the details of the adapter body of the modular adapter sub-assembly of FIGS. 5-8;

FIGS. 22 and 23 are perspective views of the adapter of the modular adapter sub-assembly of FIGS. 5-8.

FIG. 24 is perspective view of the retainer of the modular adapter sub-assembly of FIGS. 5-8; and

FIGS. 25 and 26 are perspective views of a keeper of the modular adapter sub-assembly of FIGS. 5-8.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed herein are directed to a push-button actuator 310A formed by a first piece and a second piece and may have a seal fitted about the push-button actuator for sealing with a portion of a fiber optic terminal. The push-button concepts are useful as a portion of fiber optic terminals that provide at least one connection port for receiving an external fiber optic connector in the device for indoor, outdoor or other environments as desired. Generally speaking, the devices disclosed that use the push-button actuator explained in the exemplary embodiments are fiber optic terminal also known as multiports, but the concepts disclosed may be used with any suitable device as appropriate. As used herein, the term “terminal” means any device comprising at least one connection port for making an optical connection and a securing feature associated with the at least one connection port that is actuated by a push-button. By way of example, the terminal may be any suitable device having at least one optical connection such as a passive device like an optical closure (hereinafter “closure”) or an active device such as a wireless device having electronics for transmitting or receiving a signal.

The concepts disclosed advantageously allow improved push-button actuator designs for use with compact form-factors in devices such as terminals comprising at least one connection port and a securing feature associated with the connection port that is actuated by the push-button actuator for releasing an external fiber optic connector that may be received in the connection port of the terminal. The concepts are scalable to any suitable count of connection ports on a device in a variety of arrangements or constructions. The securing features actuated by the push-buttons disclosed herein engage directly with a portion of the external fiber optic connector without conventional structures like prior art devices that require the turning of a coupling nut, bayonet or the like. As used herein, “securing feature” excludes threads and features that cooperate with bayonets on a connector. Thus, the devices disclosed may allow connection ports to be closely spaced together and may result in small devices since the room needed for turning a threaded coupling nut or bayonet is not necessary. The compact form-factors may allow the placement of the devices in tight spaces in indoor, outdoor, buried, aerial, industrial or other applications while providing at least one connection port that is advantageous for a robust and reliable optical connection in a removable and replaceable manner. The disclosed devices may also be aesthetically pleasing and provide organization for the optical connections in manner that the prior art terminals cannot provide.

The devices using push-button actuators disclosed are simple and elegant in their designs. The devices disclosed comprise at least one connection port and a securing feature associated with the connection port that is suitable for retaining an external fiber optic connector received by the connection port and released by using the push-button actuator. The connection port may include a keying portion that cooperates with a key on a complimentary external fiber optic connector to inhibit damage to the connection port by inhibiting the insertion of a non-compliant connector. The keying portion may also aid the user during blind insertion of the connector into the connection port of the device to determine the correct rotational orientation with respect to the connection port when a line of sight is not possible or practical for alignment.

Unlike prior art terminals, the concepts disclosed advantageously allow the quick and easy connection and retention by inserting the fiber optic connectors directly into the connection port of the device without the need or space considerations for turning a threaded coupling nut or bayonet for retaining the external fiber optic connector. Generally speaking, the securing features disclosed for use with devices herein may comprise one or more push-button actuators that cooperate with securing members that translate for releasing or securing the external fiber optic connector to the device. As used herein, the term “securing feature” excludes threaded portions or features for securing a bayonet disposed on a connector.

Since the connector footprint used with the devices disclosed does not require the bulkiness of a coupling nut or bayonet, the fiber optic connectors used with the devices disclosed herein may be significantly smaller than conventional connectors used with prior art terminals. Moreover, the present concepts also allow an increased density of connection ports per volume of the shell or increased port width density since there is no need for accessing and turning the coupling nut or bayonets by hand for securing a fiber optic connector like the prior art terminals.

The push-button actuators disclosed cooperate with respective securing features that directly engage with a suitable portion of a connector housing of the external fiber optic connector or the like for securing an optical connection with the device. Different variations of the concepts are discussed in further detail below. The structure for securing the fiber optic connectors in the devices disclosed allows much smaller footprints for both the devices and the fiber optic connectors along with a quick-connect feature. Devices may also have a dense spacing of connection ports if desired. The devices disclosed advantageously allow a relatively dense and organized array of connection ports in a relatively small form-factor while still being rugged for demanding environments. As optical networks increase densifications and space is at a premium, the robust and small-form factors for devices such as terminals, closures and wireless devices disclosed herein becomes increasingly desirable for network operators.

The concepts disclosed herein are suitable for optical distribution networks such as for Fiber-to-the-Home and 5G applications and are equally applicable to other optical applications as well including indoor, automotive, industrial, wireless, or other suitable applications. Additionally, the concepts disclosed may be used with any suitable fiber optic connector footprint that cooperates with the securing feature of the device. Various designs, constructions, or features for devices are disclosed in more detail as discussed herein and may be modified or varied as desired.

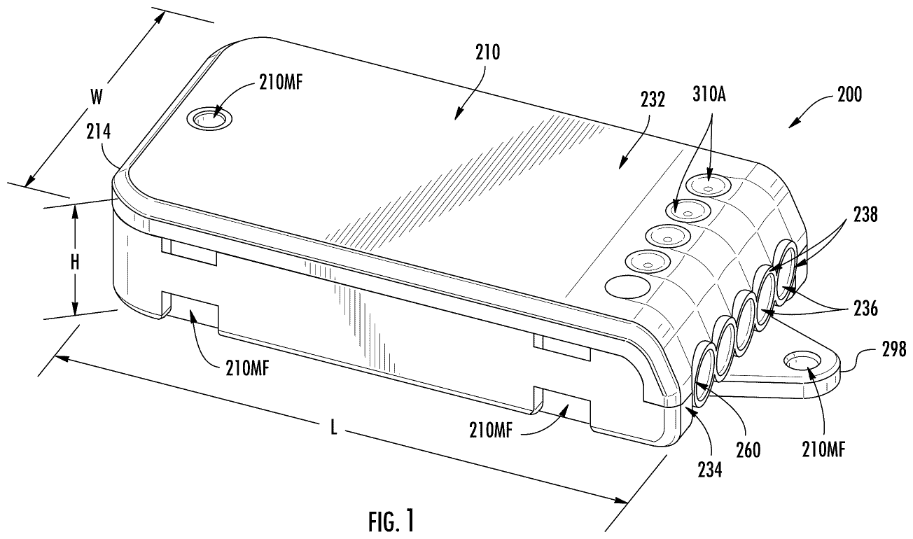

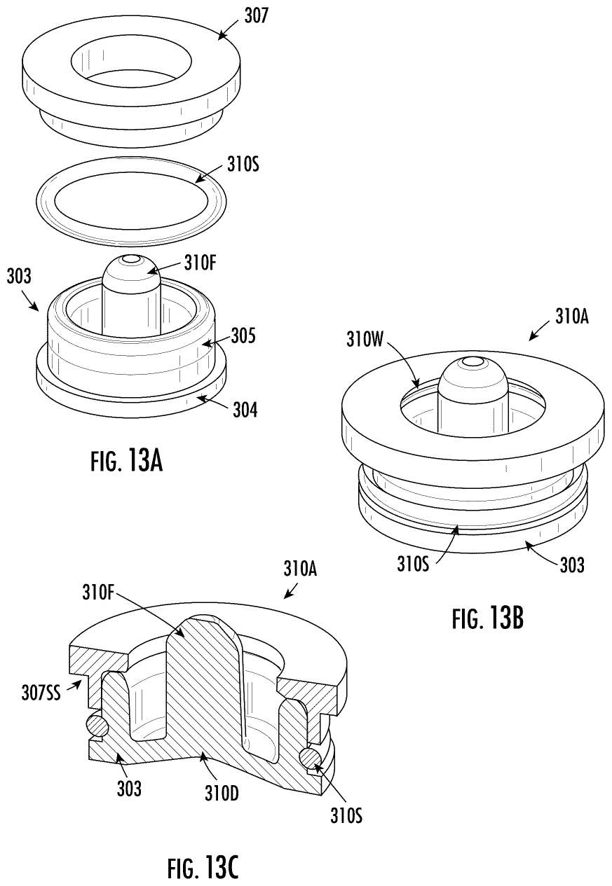

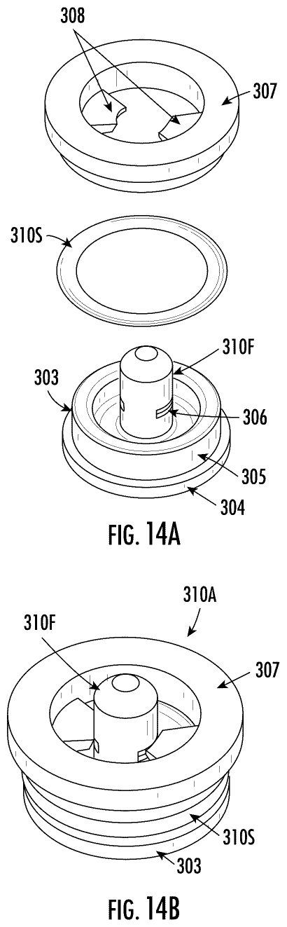

The devices disclosed may locate the at least one connection port in different portions or components of the device as desired using the disclosed concepts. The concepts are shown and described with a device 200 having four connection ports that are optically connected to an input port arranged in an array on one end of the device, but other configurations are possible such as connection ports or input ports on both ends, an express port, a pass-through port or the like. FIGS. 1-12 and 15-26 show the construction and features for an explanatory terminal that may use two-piece push-buttons as disclosed in FIGS. 13A-13C and FIGS. 14A and 14B. Although, these concepts are described with respect to terminals the concepts may be used with any other suitable devices such as wireless devices, closures or other suitable devices.

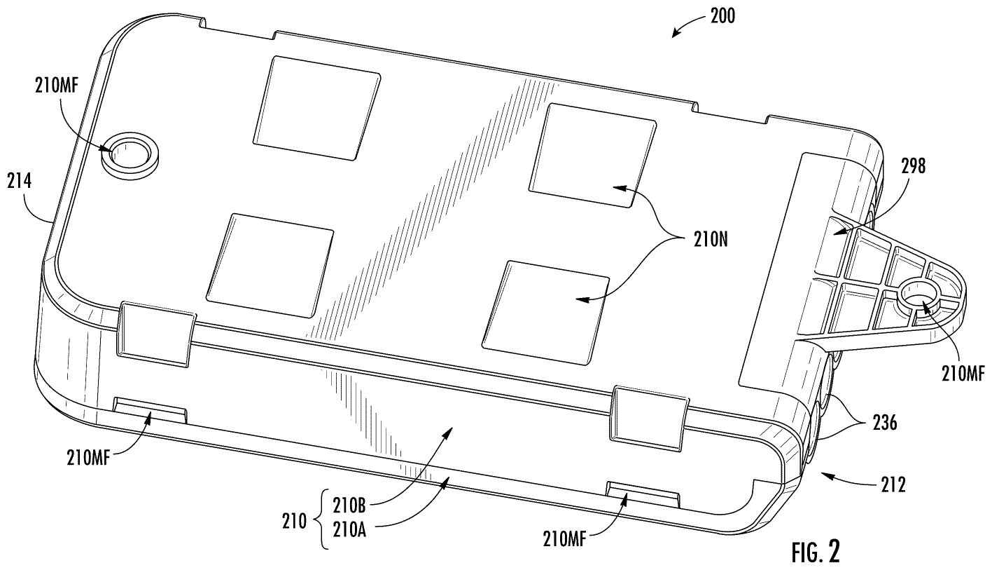

FIGS. 1 and 2 respectively depict top and bottom perspective views of the first explanatory terminal 200 comprising at least one connection port 236. The Generally speaking, devices such as terminal 200 comprise a shell 210 comprising a body 232 and one or more connection ports 236 disposed on a first end or portion 212 of terminal 200. The connection ports 236 or input port 260 are configured for receiving and retaining suitable external fiber optic connectors (not shown) for making optical connections with the terminal 200.

Connection ports 236 each comprises a respective optical connector opening 238 extending from an outer surface 234 of the terminal 200 into a cavity 216 of the terminal 200 and defining a portion of a connection port passageway 233. By way of explanation, at least one connection port 236 is molded as a portion of shell 210. At least one securing feature 310 is associated with the connection port passageway 233 for cooperating with the external fiber optic connector. The securing feature 310 may translate for releasing or securing the external fiber optic connector. Terminal 200 of FIGS. 1 and 2 also comprises an input port 260 that is similar to the connection ports 236. As shown, the connection ports 236 or input port 260 may comprise a marking indicia such as an embossed number or text, but other marking indicia are also possible. For instance, the marking indicia may be on the securing feature 310 such as text or the securing features may be color-coded to indicate fiber count, input or output for the associated connection port or input port.

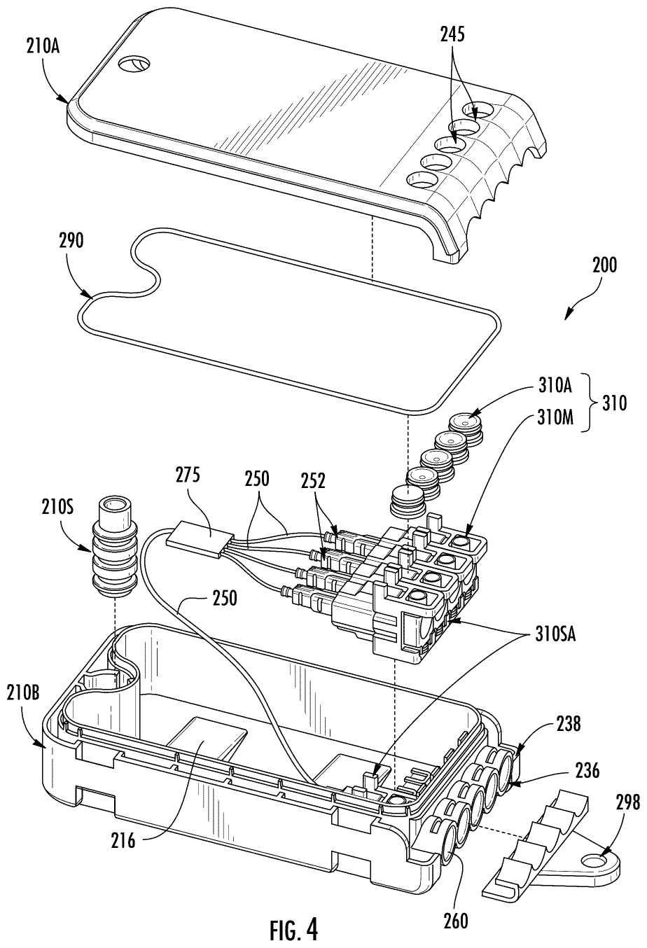

The concepts disclosed use a securing feature resilient member 310RM for biasing a portion of the securing feature 310 as discussed herein. Terminals 200 disclosed use one or more modular adapter sub-assemblies 310SA (FIGS. 5-8) disposed within a shell for a scalable form-factor for manufacturing similar devices with different port counts. The shell comprises one or more connection ports and device comprises one or more respective securing features 310 cooperating with the connection ports for providing quick and easy optical connectivity with a robust and reliable design that is intuitive to use.

Optical connections to the devices are made by inserting one or more suitable external fiber optic connectors into respective connection port passageways 233 as desired. Specifically, the connection port passageway 233 is configured for receiving a suitable external fiber optic connector (hereinafter connector) of a fiber optic cable assembly (hereinafter cable assembly). Connection port passageway 233 is associated with a securing feature 310 for retaining (e.g., securing) the connector in the terminal 200 for making an optical connection. The securing feature 310 advantageously allows the user to make a quick and easy optical connection at the connection port 236 of terminal 200. The securing feature 310 may also operate for providing a connector release feature when actuated.

Specifically, the connector may be retained within the respective connection port 236 of the device by pushing and fully-seating the connector within the connection port 236. To release the connector from the respective connection port 236, the securing feature 310 is actuated by pushing inward and releasing the securing feature 310 from the locking feature 20L on the external connector housing and allowing the connector to be removed from the connection port 236. Stated another way, the at least one securing feature 310 is capable of releasing the connector when a portion of the securing feature 310 translates within a portion of a securing feature passageway 245. The full insertion and automatic retention of the connector may advantageously allow one-handed installation of the connector by merely pushing the connector into the connection port 236. The devices disclosed accomplish this connector retention feature upon full-insertion by biasing the securing feature to a retain position. However, other modes of operation for retaining and releasing the connector are possible according to the concepts disclosed. For instance, the securing feature 310 may be designed to require actuation for inserting the connector; however, this may require a two-handed operation.

Securing feature 310 may be designed for holding a minimum pull-out force for the connector. In some embodiments, the pull-out force may be selected to release the connector before damage is done to the device or the connector. By way of example, the securing feature 310 associated with the connection port 236 may require a pull-out force of about 50 pounds (about 220N) before the connector would release. Likewise, the securing feature 310 may provide a side pull-out force for connector for inhibiting damage as well. By way of example, the securing feature 310 associated with the connection port 236 may provide a side pull-out force of about 25 pounds (about 110N) before the connector would release. Of course, other pull-out forces such as 75 pounds (about 330N) or 100 (about 440N) pounds are possible along with other side pull-out forces.

FIGS. 1 and 2 depict that shell 210 is formed by a first portion 210A and a second portion 210B, but other constructions are possible for shell 210 using the concept disclosed. Terminal 200 or devices may comprise mounting features that are integrally formed in the shell 210 or that are separate components attached to shell 210 for mounting the device as depicted in FIGS. 1 and 2. By way of example, shell 210 depicts mounting features 210MF disposed near first and second ends 212, 214 of shell 210. Mounting feature 210MF adjacent the first end 212 of terminal 200 is a mounting tab 298 attached to shell 210, and the mounting feature 210MF adjacent the second end 214 is a through hole with a support 210S. Details of support 210S will be discussed in further detail with respect to FIG. 4. However, mounting features 210MF may be disposed at any suitable location on the shell 210 or connection port insert 230. For instance, terminal 200 also depicts a plurality of mounting features 210MF integrally-formed on shell 210 and configured as passageways disposed on the lateral sides. Thus, the user may simply use a fastener such as a zip-tie threaded thru these lateral passageways for mounting the terminal 200 to a wall or pole as desired. Shell 210 may also include one or more notches 210N on the bottom side for aiding in securing the device to a round pole or the like as shown in FIG. 2.

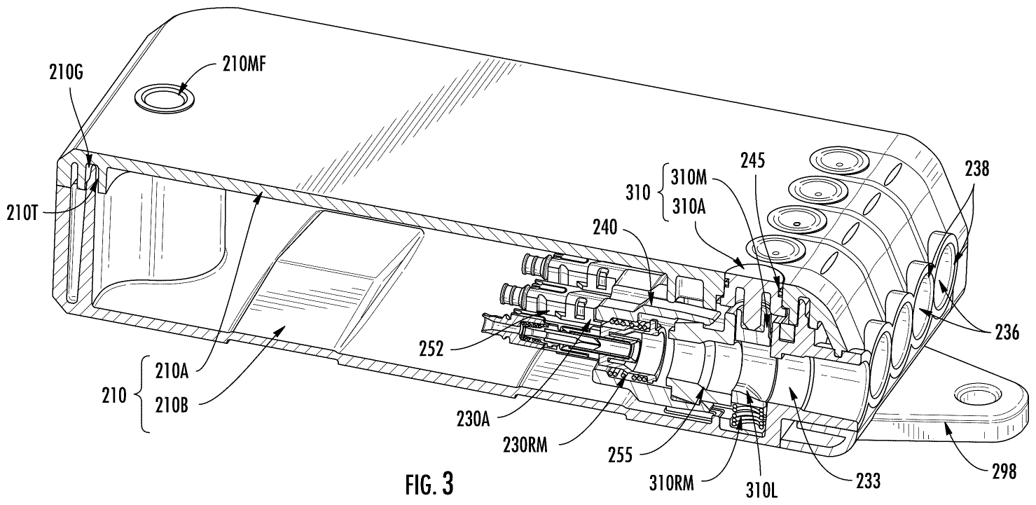

FIG. 3 depicts a cross-section through a connection port passageway 233 showing the internal construction of terminal 200, and FIG. 4 is a partially exploded view of terminal 200 showing the optical fibers 250 that optically connect the connection ports 236 with the input port 260 inside the device. As depicted in FIG. 4, terminal 200 comprises a shell 210 comprising at least one connection port 236, and a modular adapter sub-assembly 310SA as discussed in further detail herein.

FIG. 5 depicts the terminal 200 comprising at least one connection port 236 extending from an outer surface 234 of the terminal 200 into a cavity 216 of the terminal 200 and defining a connection port passageway 233. Terminal 200 also comprises at least one securing feature 310 associated with the connection port passageway 233. Terminal 200 also comprises at least one securing feature passageway 245 for receiving a portion of the securing feature 310. As depicted, the securing feature passageways 245 extend from the outer surface 234 of terminal 200 to cooperate with the respective connection port passageways 233 of the terminal 200. Terminal 200 also comprises a plurality of adapters 230A for receiving respective rear connectors 252 in alignment with the respective connection port 236 for making the optical connection with the external fiber optic connector.

The securing features 310 disclosed herein may take many different constructions or configurations as desired such as being formed as a single component or a plurality of components. Securing features 310 may be biased by a resilient member 230 RM. Furthermore, the securing features 310 or portions of securing features 310 may be constructed as a portion of a modular adapter sub-assemblies 310SA such as shown in FIGS. 5-8 for easy assembly of the terminal 200. Moreover, the modular sub-assemblies 230SA advantageously allow the mating components for each connection port 236 to move or “float” independently of other mating components relative to the shell 210 for the other connection ports for preserving optical performance. “Float” means that the adapter 230A can have slight movement in the X-Y plane for alignment, and may be inhibited from over-traveling in the Z-direction along the axis of connector insertion so that suitable alignment may be made between mating connectors, which may include a biasing spring for allowing some displacement of the adapter 230A with a suitable restoring force provided by the spring.

Generally speaking, the devices disclosed comprise at least one connection port 236 defined by an optical connector opening 238 extending into a cavity 216 of the device 200, 500, 700 along with a securing feature 310 associated with the connection port 236.

As shown in FIG. 5, securing feature 310 is biased to a retain position. Specifically, the securing feature 310 is biased in an upward direction using a securing feature resilient member 310RM. More specifically, securing feature resilient member 310RM is disposed beneath securing feature 310 for biasing to a normally retain position for the securing feature 310 where the locking feature 310L is disposed in the connection port passageway 233.

The concepts disclosed herein use a push-button actuator 310A formed by a first piece 303, a second piece 307, and a seal 310S may be fitted about the push-button actuator 310A, instead of the push-button being formed as a monolithic component. Using a push-button actuator 310A formed by two-pieces advantageously provides better control of the portion that receives the seal due to part line locations and/or flashing on the part(s). By way of explanation, a monolithic push-button typically locates the part line for molding at the groove portion of the push-button that receives the seal, which may cause concerns related to the geometry of the groove portion that receives the seal and/or flashing that may remain on the groove portion. These issues related to a monolithic push-button component could cause concerns that may require further inspection of cleaning of part, impact the fit of the seal to the push-button or other concerns related to the seal over time. Thus, using an improved push-button actuator formed from a first piece and a second piece can avoid these concerns, thereby providing a robust construction and improved reliability. FIGS. 13A-C depict a first embodiment of the push-button 310A formed from two-pieces and FIGS. 14A and 14B depict a second embodiment of the push-button 310A formed from two-pieces as discussed herein.

As best depicted in FIG. 5, a portion of push-button actuator 310A is disposed within a portion of the securing feature passageway 245 and cooperates with the securing member 310M of the respective securing feature. Consequently, a portion of securing feature 310 (i.e., the actuator 310A) is capable of translating within a portion of the securing feature passageway 245. Actuator 310A may optionally comprises a finger 310F for seating within a rim 310R of securing member 310M for transferring forces to the same as shown, but the engagement portion of the push-button actuator 310A need not have a protruding finger as depicted. By way of example, the engagement portion of the push-button actuator 310A may be a flat surface or a cupped surface to cooperate with the securing member 310M geometry as desired. As depicted, a sealing feature 310S is disposed on the securing feature 310A. Sealing feature 310S provides a seal between a portion of the securing feature 310A and the securing feature passageway 245 to inhibit dirt, dust and debris from entering the device. As shown, the scaling feature 310S is sized for fitting about a portion of first piece of the push-button actuator 310A. Further details of the push-button actuator 310A are discussed below.

In this embodiment, the securing feature 310 comprises a bore 310B that is aligned with the least one connection port passageway 233 when assembled. Bore 310B is sized for receiving a suitable connector therethrough for securing the same for optical connectivity. Bores or openings through the securing feature 310 may have any suitable shape or geometry for cooperating with its respective connector. As used herein, the bore may have any suitable shape desired including features on the surface of the bore for engaging with a connector. Bore 310B is disposed on the securing member 310M in this embodiment.

In some embodiments, a portion of the securing feature 310 is capable of moving to an open position when inserting a suitable external connector into the connection port passageway 233. When the external connector is fully-inserted into the connector port passageway 233, the securing feature 310 such as the securing member 310M is capable of moving to the retain position automatically. Consequently, the external connector is secured within the connection port 236 by securing feature 310 without turning a coupling nut or a bayonet like the prior art terminals. Stated another way, the securing feature 310 translates from the retain position to an open position as a suitable external connector is inserted into the connection port 236. The securing feature passageway 245 is arranged transversely to a longitudinal axis LA of the terminal 200, but other arrangements are possible. Other securing features may operate in a similar manner by using an opening instead of a bore that receives the connector therethrough.

Securing feature 310 may comprise a locking feature 310L as shown in FIG. 5. Locking feature 310L cooperates with a portion of the external connector when it is fully-inserted into the connection port 236 for securing the same. A connector housing of external connector may have a cooperating geometry that engages the locking feature 310L of securing feature 310. In this embodiment, locking feature 310L comprises a ramp 310RP. The ramp is integrally formed at a portion of the bore 310B with the ramp angling up when looking into the connection port 236. The ramp allows the connector to push and translate the securing feature 310 downward against the securing feature resilient member 310RM as the connector is inserted in the connection port 236 as shown. Ramp may have any suitable geometry. Once the locking feature 310L of the securing feature 310 is aligned with the cooperating geometry of the locking feature 20L of connector, then a portion of the securing feature 310 translates so that the locking feature 310L engages the locking feature of connector.

Locking feature 310L comprises a retention surface 310RS. In this embodiment, the back-side of the ramp of locking feature 310L forms a ledge that cooperates with complimentary geometry on the connector housing of connector. However, retention surface 310RS may have different surfaces or edges that cooperate for securing connector for creating the desired mechanical retention. For instance, the retention surface 310RS may be canted or have a vertical wall for tailoring the pull-out force for the connection port 236. However, other geometries are possible for the retention surface 310RS. Additionally, the connection port 236 has a sealing location at a connection port passageway sealing surface with the connector that is located closer to the optical connector opening 238 at the outer surface 234 than the securing feature 310 or locking feature 310L. In other words, connection port 236 has connection port passageway sealing surface for the connector disposed at a distance from the optical connector opening 238 and the locking feature 310L and securing feature 310 are disposed at a distance further into the connection port passageway 233 than distance where the connector sealing occurs.

Generally speaking, the connection port passageways 233 may be configured for the specific connector intended to be received in the connection port 236. Likewise, the connection port passageways 233 should be configured for receiving the specific rear connector 252 for mating and making an optical connection with the external connector.

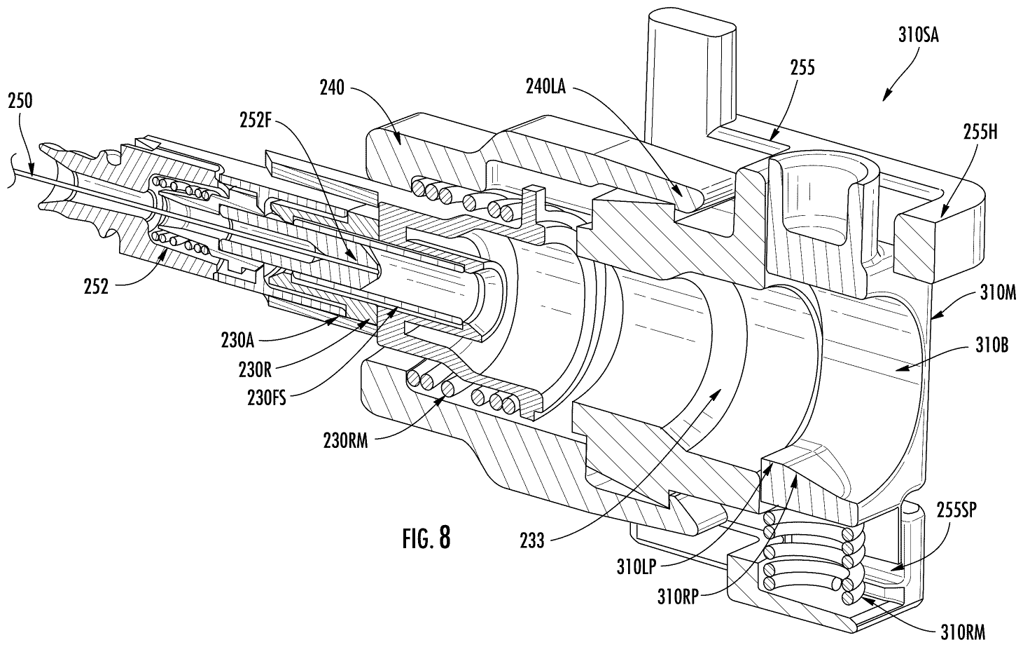

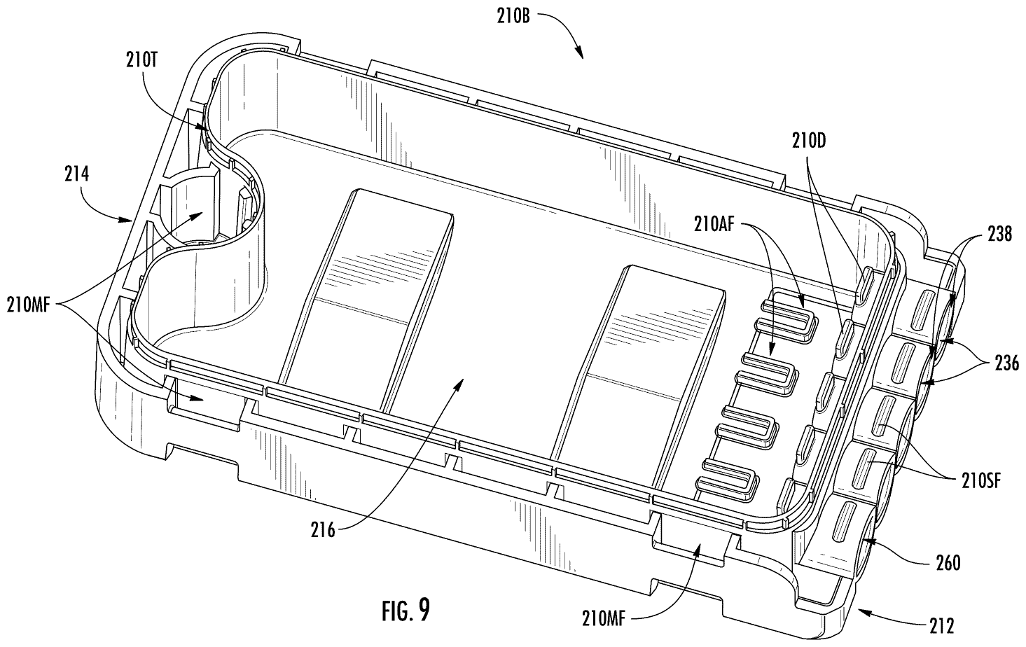

The device 200 also comprises at least one adapter 230A aligned with the respective connection port 236 or connection port passageway 233. Adapter 230A and other components are a portion of the modular sub-assembly 310SA as depicted in FIGS. 9-12. Adapter 230A is suitable for securing a rear connector 252 thereto for aligning the rear connector 252 with the connection port 236. One or more optical fibers 250 (FIG. 8) may be routed from the connection port 236 toward an input connection port 260 of the terminal 200. For instance, the rear connector 252 may terminate the optical fiber 250 for optical connection at connection port 236 and route the optical fiber 250 for optical communication with the input connection port 260.

A plurality of rear connectors 252 are aligned with the respective connector port passageways 233 within the cavity 216 of the terminal 200. The rear connectors 252 are associated with one or more of the plurality of optical fibers 250. Each of the respective rear connectors 252 aligns and attaches to a structure such as the adapter 230A or other structure related to the connection port passageway 233 in a suitable matter. The plurality of rear connectors 252 may comprise a suitable rear connector ferrule 252F as desired and rear connectors 252 may take any suitable form from a simple ferrule that attaches to a standard connector type inserted into an adapter. By way of example, rear connectors 252 may comprise a resilient member for biasing the rear connector ferrule 252F or not. Additionally, rear connectors 252 may further comprise a keying feature.

The rear connectors 252 shown in FIG. 5 have a SC footprint, but other connectors are possible. If SC connectors are used as the rear connector 252 they have a keying feature 252K that cooperates with the keying feature of adapter 230A. Additionally, adapters 230A comprise a retention feature (not numbered) for seating the adapters 230A in the device adjacent to the connection port passageway 233.

The connection port passageway 233 may comprises a keying portion (not numbered) disposed forward of the securing feature 310 in connection port passageway. As shown in FIG. 5, the keying portion is an additive keying portion to the primitive geometric round shape of the connection port passageway 233 such as a male key that is disposed forward of the securing feature in the connection port passageway 233. However, the concepts for the connection ports 236 of devices may be modified for different connector designs.

Adapters 230A are secured to an adapter body 255 using retainer 240. Adapters 230A may be biased using a resilient member 230RM as shown. Rear connectors 252 may take any suitable form and be aligned for mating with the connector secured with the connection ports 236 in any suitable manner. Adapters 230A may comprise latch arms for securing respective rear connectors therein.

Terminal 200 may have the input connection port 260 disposed in any suitable location. As used herein, “input connection port” is the location where external optical fibers are received or enter the device, and the input connection port does not require the ability to make an optical connection as discussed below. By way of explanation, terminal 200 may have the input connection port 260 disposed in an outboard position of the array of connection ports 236, on another side of the terminal, or disposed in a medial portion of array of connection ports 236 as desired.

FIG. 4 shows a partially exploded view of terminal 200 of FIGS. 1 and 2. Terminal 200 comprises a shell 200, at least one connection port 236, and a plurality of modular adapter sub-assemblies 310SA. Terminal 200 has one or more optical fibers 250 routed from the one or more connection ports 236 toward an input connection port 260 in a suitable fashion inside cavity 216 as depicted. In this embodiment, the rear connectors 252 are attached to optical fibers 250 that are routing through an optical splitter 275 (hereinafter “splitter(s)”) for optical communication with the optical fiber 250 in optical communication with the input port 260. As shown, the modular adapter sub-assembly 310SA for the input connection port 260 is disposed in second portion 210B of shell 210.

Optical fibers 250 are routed from one or more of the plurality of connection ports 236 toward an input connection port 260 for optical communication within the terminal 200. Consequently, the input connection port 260 receives one or more optical fibers and then routes the optical signals as desired such as passing the signal through 1:1 distribution, routing through an optical splitter or passing optical fibers through the terminal. Splitters 275 such as shown in FIG. 4 allow a single optical signal to be split into multiple signals such as 1×N split, but other splitter arrangements are possible such as a 2×N split. For instance, a single optical fiber may feed input connection port 260 and use a 1×8 splitter within the terminal 200 to allow eight connector ports 236 for outputs on the terminal 200. The input connection port 260 may be configured in a suitable manner with any of the terminals 200 disclosed herein as appropriate such as a single-fiber or multi-fiber port. Likewise, the connection ports 236 may be configured as a single-fiber port or multi-fiber port. For the sake of simplicity and clarity in the drawings, all of the optical fiber pathways may not be illustrated or portions of the optical fiber pathways may be removed in places so that other details of the design are visible.

Additionally, the terminals or shells 210 may comprise at least one support 210S or fiber guide for providing crush support for the terminal and resulting in a robust structure. As depicted in FIG. 4, terminal 200 may comprise a support 210S configured as a support insert that fits into shell 210. Support 210S has a bore therethrough and may act as a mounting feature for the use to a fastener to mount the terminal 200. Consequently, the support 210S carries the majority of any crushing forces that may be applied by the fastener and inhibits damage to the shell 210. Support 210S may also be located and attached to the shell at a location outside of the sealing interface between the first portion 210A and the second portion 210B of shell 210.

Shell 210 may also comprise interlocking features between the first portion 210A and the second portion 210B. Specifically, portions of the shell 210 of the terminal may have a tongue 210T and groove 210G construction for alignment or sealing of the device.

Any of the terminals 200 disclosed herein may optionally be weatherproof by appropriately sealing seams of the shell 210 using any suitable means such as gaskets, O-rings, adhesive, sealant, welding, overmolding or the like. To this end, terminal 200 or devices may also comprise a sealing element 290 disposed between the first portion 210A and the second portion 210B of the shell 210. The sealing element 290 may cooperate with shell 210 geometry such as respective grooves 210G or tongues 210T in the shell 210. Grooves or tongue may extend about the perimeter of the shell 210. By way of explanation, grooves 210G may receive one or more appropriately sized O-rings or gaskets 290A for weatherproofing terminal 200, but an adhesive or other material may be used in the groove 210G. By way of example, the O-rings are suitably sized for creating a seal between the portions of the shell 210. By way of example, suitable O-rings may be a compression O-ring for maintaining a weatherproof seal. Other embodiments may use an adhesive or suitable welding of the materials for sealing the device. If welding such as ultra-sonic or induction welding of the shell is used a special sealing element 290 may be used as known in the art. If the terminal 200 is intended for indoor applications, then the weatherproofing may not be required.

As shown in FIG. 4, terminal 200 comprises a single input optical fiber of the input connection port 260 is routed to a 1:4 splitter 275 and then each one of the individual optical fibers 250 from the splitter is routed to each of the respective rear connector 252 of the four connection ports 236 for optical connection and communication within the terminal. Input connection port 260 may be configured in any suitable configuration for the terminals disclosed as desired for the given application. Examples of input connection ports 260 include being configured as a single-fiber input connection, a multi-fiber input connector, a tether input that may be a stubbed cable or terminated with a connector or even one of the connection ports 236 may function as a pass-through connection port as desired.

By way of explanation for multi-fiber ports, two or more optical fibers 250 may be routed from one or more of the plurality of connection ports 236 of the terminal 200 disclosed herein. For instance, two optical fibers may be routed from each of the four connection ports 236 of terminal 200 toward the input connection port 260 with or without a splitter such as single-fiber input connection port 260 using a 1:8 splitter or by using an eight-fiber connection at the input connection port 260 for a 1:1 fiber distribution. To make identification of the connection ports or input connection port(s) easier for the user, a marking indicia may be used such as text or color-coding of the terminal, color codes on the actuator 310A, or marking the input tether (e.g., an orange or green polymer) or the like.

Other configurations are possible besides an input connection port 260 that receives an external connector. Instead of using an input connection port that receives an external connector, terminals 200 may be configured for receiving an input tether 270 attached to the terminal at the input connection port 260.

FIGS. 5-8 show modular adapter sub-assembly 310SA used in the terminal of FIGS. 1 and 2. Modular adapter sub-assemblies 310SA enable quick and easy assembly of terminals 200 in a scalable manner. Moreover, the modular sub-assemblies 230SA advantageously allow the mating components (i.e., the adapters 230A) corresponding to each connection port 236 to move or “float” independently of other the other modular adapter sub-assemblies 310SA relative to the shell 210 for preserving optical performance.

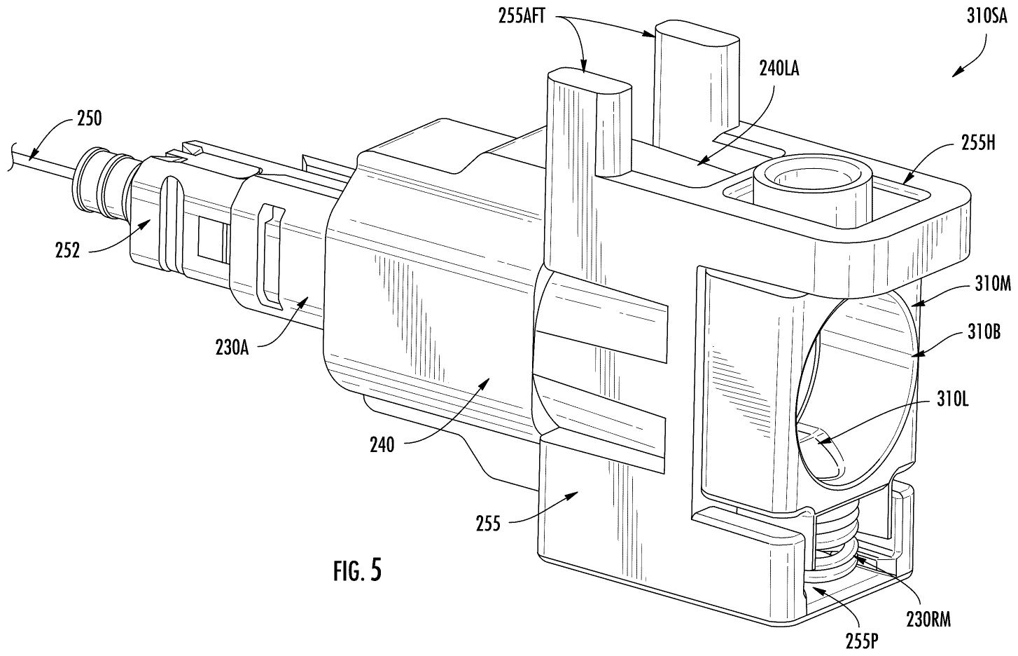

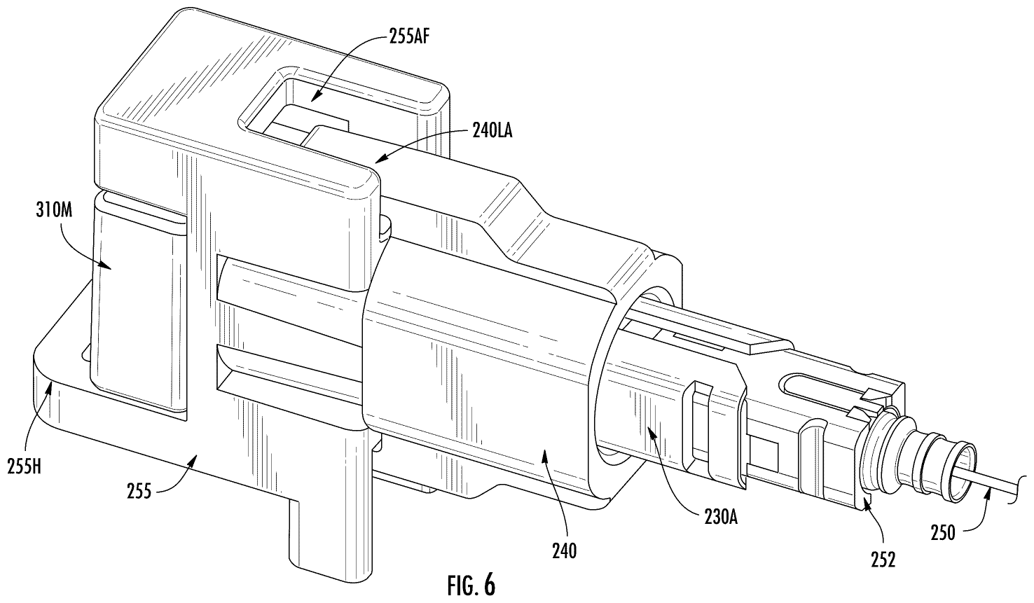

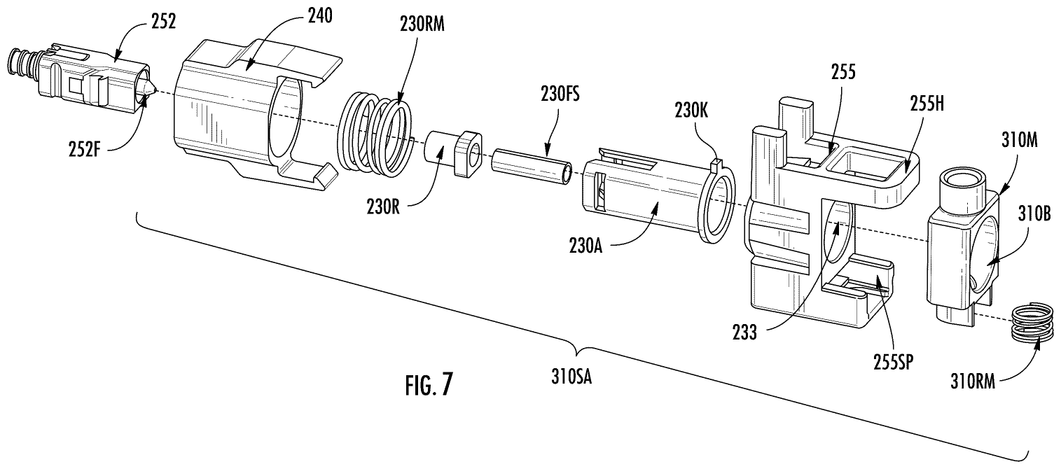

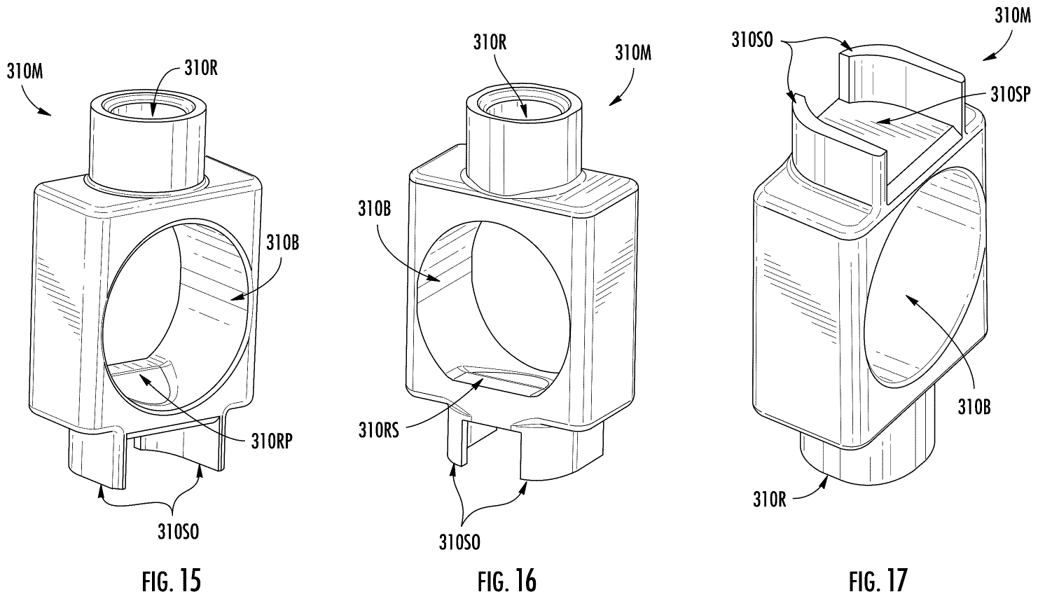

FIGS. 5 and 6 respectively show front and rear perspective views of modular adapter sub-assemblies 310SA with a rear connector 252 attached to the adapter 230A. FIG. 7 depicts an exploded view of the modular adapter sub-assemblies 310SA and shows that the rear connector 252 is not a portion of modular adapter sub-assembly 310SA, and FIG. 8 is a cross-sectional view of the modular adapter sub-assembly 310SA. Modular adapter sub-assemblies 310SA comprises an adapter 230A aligned with the at least one connection port 236 when assembled. Adapter 230 may be biased by a resilient member 230RM. The adapter (230A) may be secured to the adapter body 255 using retainer 240. FIGS. 15-26 show details of select components of the modular adapter sub-assembly 310SA.

As best shown in FIG. 7, modular adapter sub-assembly 310SA may comprise a portion of securing feature 310 and a securing feature resilient member 310RM. Specifically, modular adapter sub-assembly 310SA comprises securing member 310M. The securing member 310M cooperates with a push-button actuator 310A that is configured from two separate pieces that are attached together for forming the push-button actuator 310A. Using a push-button actuator 310A formed from two-pieces allows better control of the surfaces of the push-button actuator that receives a seal, thereby aiding in reliability for sealing the terminal 200 with the push-button actuator 310A. Securing member 310M is inserted into a front end of an adapter body 255 along with securing feature resilient member 310RM. Specifically, the rim 310R of securing member 310M is inserted into a hoop 255H of adapter body 255 and standoffs 310SO are disposed in a portion of the resilient member pocket 255SP at the bottom of the adapter body 255. Securing feature resilient member 310RM is disposed in the resilient member pocket 255SP for biasing the securing member 310M to a retain position as shown in FIG. 8. This construction advantageously keeps the assembly intact using the securing feature resilient member 310RM. Standoffs 310SO of adapter body 255 may also act as stops to limit the translation of the securing member 310.

In this embodiment, modular adapter sub-assembly 310SA may comprises an adapter body 255, securing member 310M, securing feature resilient member 310RM, a ferrule sleeve 230FS, a ferrule sleeve retainer 230R, resilient member 230RM, a retainer along with the adapter 230A. Adapter body 255 has a portion of the connection port passageway 233 disposed therein.

As best depicted in FIGS. 7 and 8, the is resilient member 230RM is disposed over a barrel of adapter 230A and seated on the flange of adapter 230A as depicted, then retainer 240 can be attached to adapter body 255 using latch arms 240LA to secure the same. Ferrule sleeve retainer 230R and ferrule sleeve 230FS are aligned for assembly into the adapter 230A for assembly as shown in FIG. 7 and seated using the ferrule sleeve retainer 230R. Of course, other variations of the modular adapter sub-assembly 310SA are possible.

FIGS. 9 and 10 depict detailed views of the second portion 210B of shell 210 with the internal components removed for showing the internal construction of the terminal 200 of FIGS. 1 and 2. Shells 210 may have any suitable shape, design or configuration as desired. Second portion 210B cooperates with first portion 210A to form shell 210. Second portion 210B comprises a plurality of connection ports 236 and input connection port 260. Second portion 210B provides a portion of cavity 216 of terminal 200, and the internal bottom surface of second portion 210B comprises a plurality of alignment features 210AF for aligning the modular adapter sub-assembly 310SA with the respective connection ports 236. Alignment features 210AF have a U-shape and cooperate with the alignment features 255AF on the bottom of adapter body 255. Second portion 210B also includes a plurality of studs 210D on top of the respective connection ports 236 within cavity 216 for seating the hoop 255H of the adapter body 255 for assembly. Second portion 210B may also include a plurality of guide features 210SF for aligning the first portion 210A with the second portion 210B of the shell 210.

FIG. 11 depicts the assembly of modular sub-assemblies 310SA into the second portion 210B of shell 200. As shown, modular adapter sub-assemblies 310AS are aligned and installed onto the U-shaped alignment features 210AF of the second portion 210B of shell 210 as discussed. FIG. 20 shows a representation of the alignment features 210AF of the second portion 210B of shell 210 cooperating with the alignment features 255AF on the bottom of adapter body 255 in another embodiment. FIG. 11 also shows the hoops 255H of the adapter bodies 255 disposed about the plurality of studs 210D on top of the respective connection ports 236 within cavity 216 for aligning the modular adapter sub-assembly 310SA within the second portion 210B of shell 210 for aligning the connection port passageway 233 of the adapter body 255 with the connection port passageway 233 of the shell 210. FIG. 11 also shows the support 210S placed into the respective bore of the second portion 210B of the shell. As depicted, support 210S is located outside of the sealing interface of the second portion 210B of shell 210.

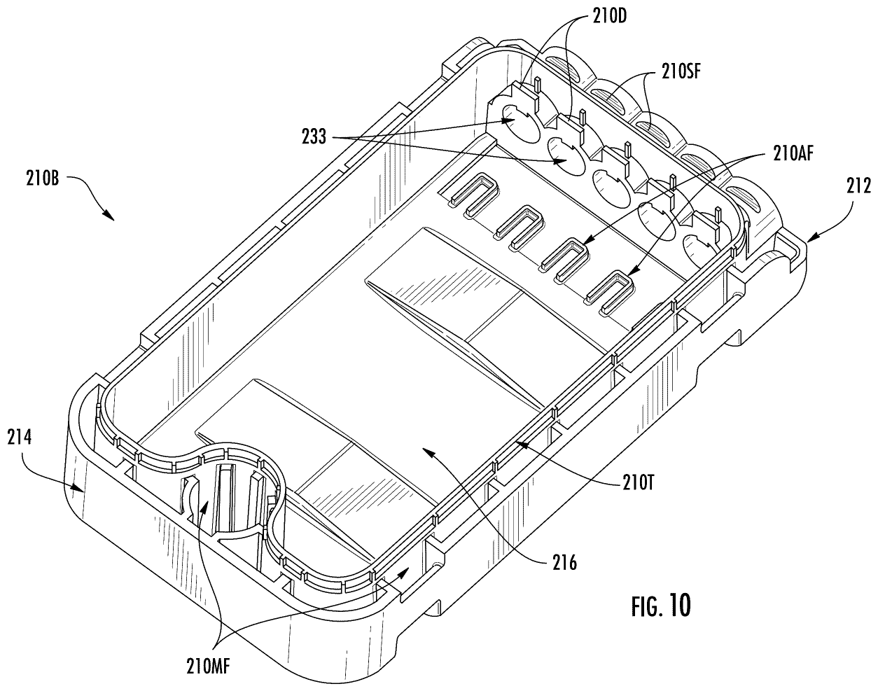

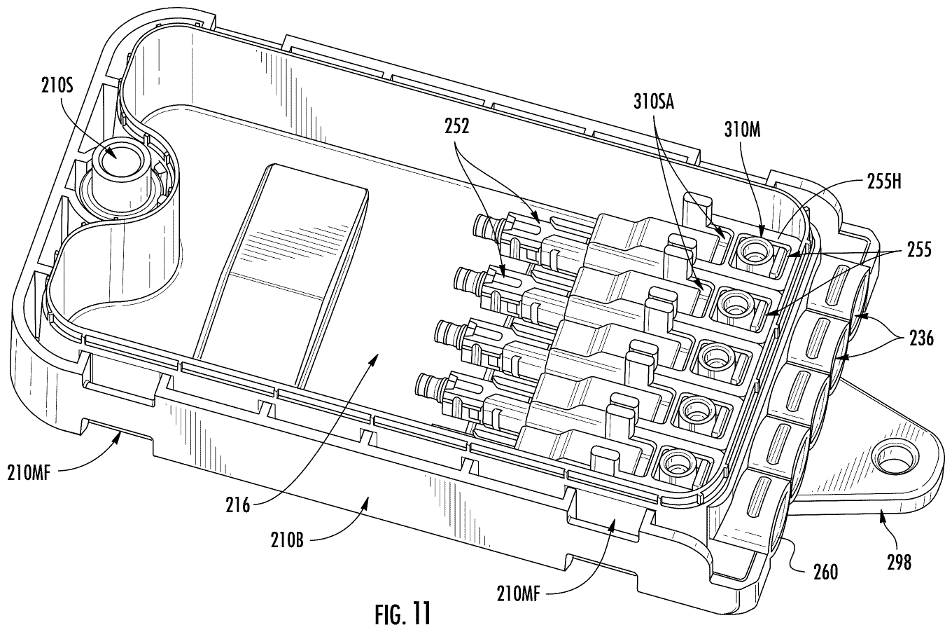

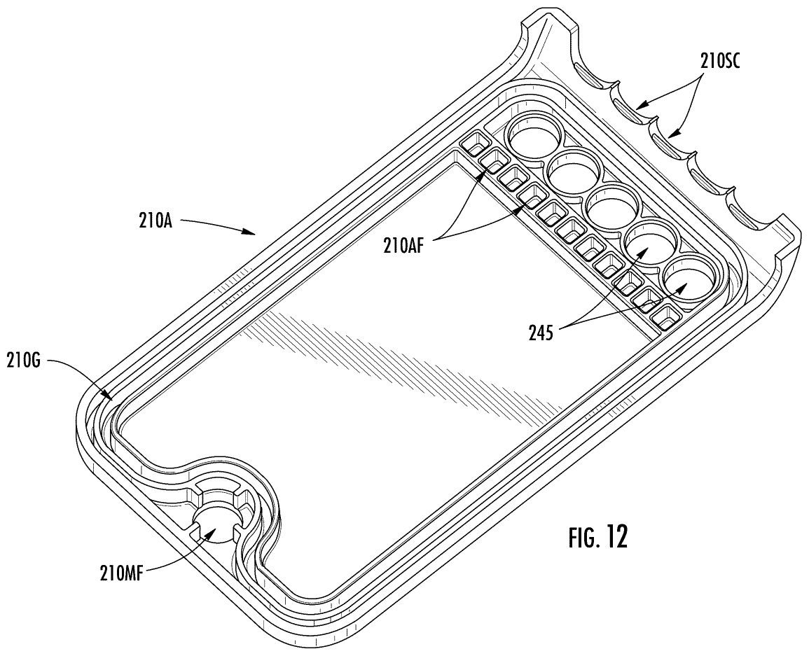

FIG. 12 depicts an inside surface of the first portion 210A of shell 200. As shown, first portion 210A comprises a profile that conforms to the profile of the second portion 210B of shell 210. By way of explanation, first portion 210A comprises a plurality of scallops 210SC for cooperating with the connection ports 236 on the second portion 210B of shell 210. First portion 210A also comprise a sealing perimeter that cooperates with the sealing perimeter of the second portion 210B of shell 210. First portion 210A also comprises alignment features 210AF sized and shaped for cooperating with the alignment features 255AFT on the top of adapter body 255 for securing the same when the terminal is assembled. The respective alignment features 210AF,255AF only allow assembly of the modular adapter sub-assemblies 310AS into the shell 210 in one orientation for the correct orientation of the locking feature 310L with respect to the connection port 236.

Terminal may include a fiber tray or fiber guide/supports that are discrete components that may attach to the shell 210; however, fiber guides may be integrated with the shell if desired. Shell may also 210 comprise one or more fiber guides for organizing and routing optical fibers 250. The fiber tray inhibits damage to optical fibers and may also provide a location for the mounting of other components such as splitters, electronics or the like if desired. Fiber guides may also act as support 210S for providing crush strength to the shell 210 if they have a suitable length.

The push-button actuators 310A used for releasing external fiber optic connectors from respective connection ports 236 of terminal 200 may have any suitable construction formed from a first piece and a second piece according to the concepts disclosed. FIGS. 13A-13C show views of a first push-button actuator 310A according to the concepts. As shown in the exploded view of FIG. 13A, the first piece 303 has first diameter 304 and a second diameter 305 with the first diameter 304 being larger than the second diameter 305. The first diameter 304 forms the top portion of the push-button actuator 310A that is exposed on the fiber optic terminal 200. In this embodiment, second piece 307 is configured as an annular ring that cooperates with the first piece 303 such as depicted in FIGS. 13A-13-C, but the second piece 307 could alternatively be formed as a disc if desired.

As depicted in FIGS. 13B and 13C, a portion of the second piece 307 fits about part of the first piece 303 and defining a location between the first piece 303 and the second piece 307 for capturing the seal 310S. Having a portion of the second piece 307 that fits about the part of the first piece 303 also aids in the alignment and assembly of the first piece 303 and the second piece 307. As depicted in FIG. 13C, the second piece 307 may have a T-shaped cross-section for fitting about the first piece 303 and providing a stop surface, but other sections are possible with the concepts. Before assembling the second piece 307 to the first piece 303, the push-button actuator 310A may have a seal 310S fitted about the second diameter 305 of the first piece 303 as depicted. The seal 310S is suitable for keeping dirt, debris and the like out of portions of the terminal 200 when assembled into the shell 210 of the same (i.e., the securing feature passageway 245). Seal 310S is sized for the surface 310RS formed by the second diameter 305 of the first piece 303 of the push-button actuator. Seal 310S may be an O-ring, but other types of seals may be used with the concepts disclosed.

The push-button actuator 310A is configured for engaging the securing member 310M. For instance, push-button actuator 310A comprises a surface such as a protrusion, flat or other feature for engaging with the securing member 310M for releasing an external fiber optic connector. By way of example, and not limitation, first portion 303 may comprise a finger 310F protruding from a first side as shown for seating within a rim 310R of securing member 310M for transferring forces to the same, but other arrangements are possible. As depicted, the finger 310F extends thru the annual ring of the second piece 307 when assembled.

The second piece 307 may also comprise a stop surface 307SS for inhibiting overtravel of the push-button actuator 310A for inhibiting the push-button actuator from being removed from the terminal 200 when assembled. The first piece 303 may also include a dimple 310D or other feature for inhibiting inadvertent activation/translation of the securing feature 310 or allowing a tactical feel for the user.

The first piece 303 and second piece 307 may comprise from any suitable material(s) and attached in any suitable manner to form the push-button actuator. For instance, the first piece 303 and second piece 307 may comprise different materials or the same material as desired. In one variation, the second piece 307 may comprise a transmissive material for allowing a predetermined wavelength (i.e., light, laser, etc.) to pass through the transmissive material for allowing the welding of the second piece to the first piece. By way of example and not limitation, the second piece 307 may be an Ultem® material that allows predetermined wavelength to penetrate the material for laser welding of the second piece 307 to the first piece 303 if desired. In other embodiments, the second piece 307 may be secured to the first piece 303 by adhesive, snap-fit, friction fit or the like. The material of the first piece 303 may be any suitable material that cooperates with the first material using the desired securing method. For instance, the first piece may be a polycarbonate material, but other materials may be used.

FIGS. 14A and 14B show a second push-button actuator 310A that is similar to the first push-button actuator of FIGS. 13A-13C. For the sake of brevity, the differences of the second push-button actuator will be discussed and other features of the design are similar to those described herein. As shown, the push-button actuator 310A of FIGS. 14A and 14B comprise attachment features on the first piece 303 that cooperate with complimentary attachment features on the second piece 307 for securing the pieces together. The attachment features may be used with other securing methods such as welding, adhesive, friction-fit or not as desired. As best shown in FIG. 14A, the first piece 303 comprises an attachment feature formed as at least one groove disposed on the finger 310F, and the second piece 307 comprises at least one tab 308 extending inward from the annular ring of the second piece 307. As depicted in FIG. 14B, the edges of the tabs 308 of the second piece 307 fit into the groove disposed on the first piece 303 for attaching the first piece 303 to the second piece 307. Of course, other cooperating arrangements of attachment feature could be used for securing the first piece 303 to the second piece 307 as desired.

Push-button actuator 310A may also be a different color or have a marking indicia for identifying the port type. For instance, the push-button actuator 310A may be colored black for connection ports 236 and the push-button actuator 310A for the input connection port 260 may be colored red. Other color or marking indicia schemes may be used for pass-through ports, multi-fiber ports or ports for split signals as desired.

FIGS. 15-26 show details of select components of the modular adapter sub-assembly 310SA. FIGS. 15-17 show various perspective detailed views of securing member 310M. Securing member 310M comprises a locking feature 310L. Locking feature 310L is configured for engaging with a suitable locking portion 20L on the housing of the external connector. In this embodiment, securing feature 310 comprise a bore 310B that is respectively aligned with the respective connector port passageway 233 as shown in FIG. 3 when assembled. The bore 310B is sized for receiving a portion of the external connector therethrough.

As depicted in this embodiment, locking feature 310L is disposed within bore 310B of securing member 310M. As shown, locking feature 310L is configured as ramp 310RP that runs to a short flat portion, then to a ledge for creating the retention surface 310RS for engaging and retaining the external connector once it is fully-inserted into the connector port passageway 233 of the connection port 236. Consequently, the securing feature 310 is capable of moving to an open position (OP) when inserting a suitable external connector into the connector port passageway 233 since the connector housing engages the ramp 310RP pushing the securing feature downward during insertion.

Securing member 310M may also comprises standoffs 310 as best shown in FIG. 17. Standoffs 310 cooperate with the resilient member pocket 255SP of the adapter body 255 for keeping the bore 310B in the proper rotational orientation within the respective to the adapter body 255. Specifically, standoffs 310 have curved shapes that only allow the securing member 310M to fully-seat into the adapter body 255 when oriented in the proper orientation.

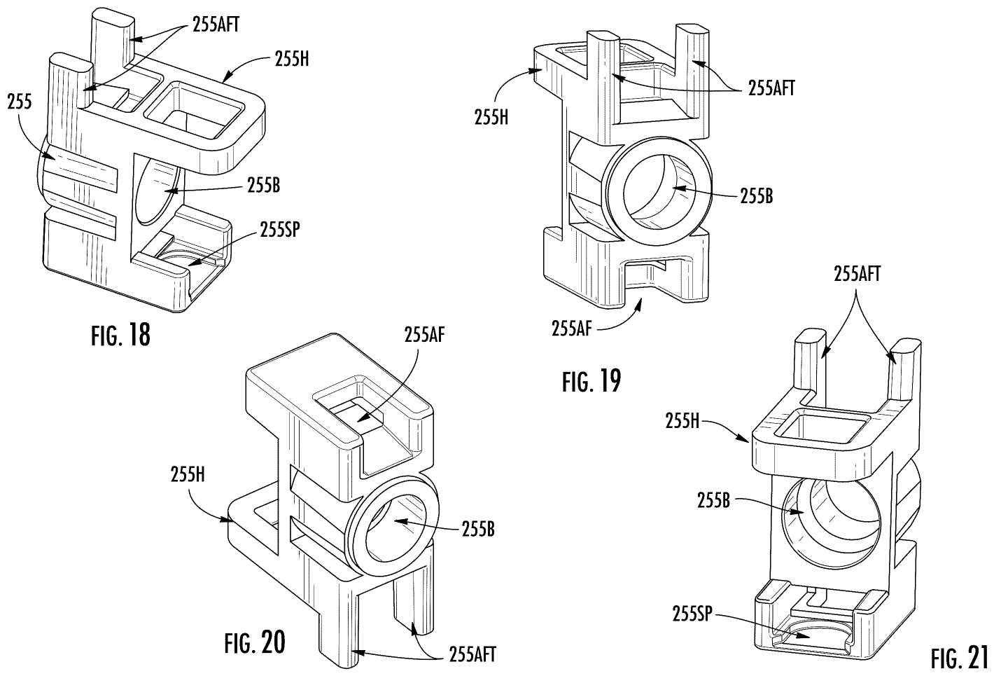

FIGS. 18-21 are various perspective views showing the details of the adapter body 255 of the modular adapter sub-assembly 310SA. Adapter body 255 comprises an adapter body bore 255B that comprises a portion of the connection port passageway 233 when assembled. As discussed, adapter body 255 comprises alignment features 255AF on the bottom of adapter body 255 that cooperate with the shell 210 to align and seat the same in the shell 210. Adapter body 255 also comprises hoop 255H. Hoop 255H captures the ring 255R at the top of the securing member 310M when assembled, and also seats the adapter body 255 in the second portion 210B of shell 210 during assembly. Adapter body 255 also comprises alignment features 255AFT on the top of adapter body 255 for securing the same in the first portion 210A of the shell 210 when the terminal 200 is assembled. Adapter body 255 also comprise resilient member pocket 255SP at the bottom of the adapter body 255 for capturing the securing feature resilient member 310RM as depicted in FIG. 8.

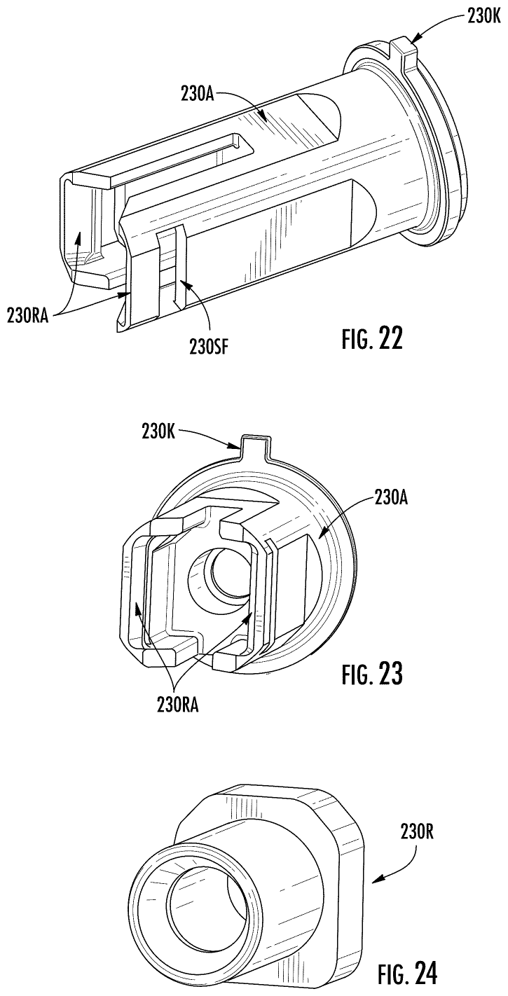

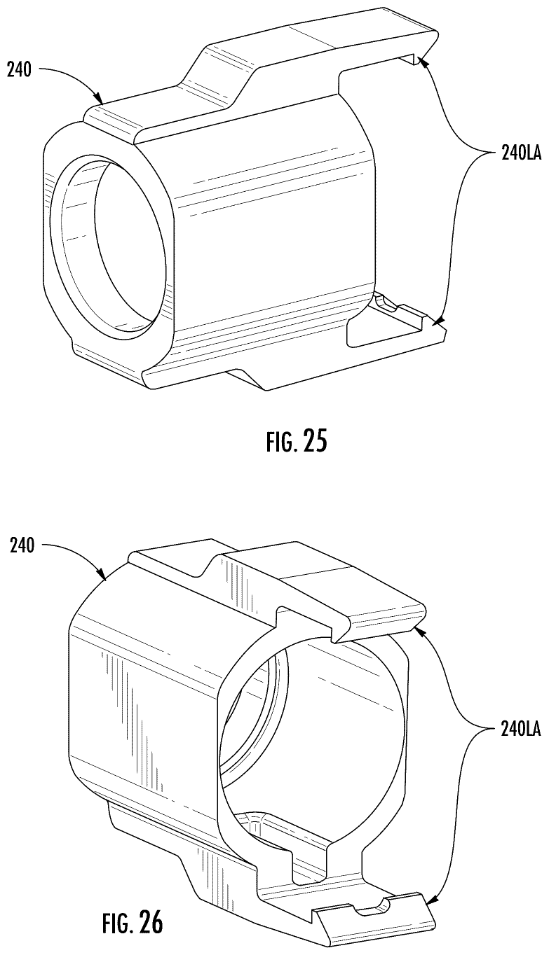

FIGS. 22 and 23 depict detailed views of adapter 230A. Adapter 230A comprises a plurality of resilient arms 230RA comprising securing features (not numbered). Adapter 230A also comprises an adapter key 230K for orientating the adapter 230A with the adapter body 255. Securing features 230SF cooperate with protrusions on the housing of rear connector 252 for retaining the rear connector 252 to the adapter 230A. The ferrule 252F is disposed within the ferrule sleeve 230FS when assembled. FIG. 8 is a sectional view showing the attachment of the rear connector 252 with the adapter 230A with ferrule sleeve retainer 230R and the ferrule sleeve 230FS therebetween. Ferrule sleeves 230FS are used for precision alignment of mating ferrules between rear connectors 252 and external connector. Devices may use alternative rear connectors if desired and can have different structures for supporting different rear connectors. FIG. 24 depicts details of the ferrule sleeve retainer 230R. FIGS. 25 and 26 show detailed views of retainer 240 that forms a portion of the modular sub-assembly 310SA. Retainer 240 comprises one or more latch arms 240LA for cooperating with the adapter body 255 for securing the adapter 230A and resilient member 230RM of the modular adapter sub-assembly 310SA.

The concepts disclosed allow relatively small terminals 200 having a relatively high-density of connections along with an organized arrangement for external connectors attached to the terminals 200. Shells have a given height H, width W and length L that define a volume for the terminal as depicted in FIG. 1. By way of example, shells 210 of terminal 200 may define a volume of 800 cubic centimeters or less, other embodiments of shells 210 may define the volume of 400 cubic centimeters or less, other embodiments of shells 210 may define the volume of 100 cubic centimeters or less as desired. Some embodiments of terminals 200 comprise a connection port insert 230 having a port width density of at least one connection port 236 per 20 millimeters of width W of the terminal 200. Other port width densities are possible such as 15 millimeters of width W of the terminal. Likewise, embodiments of terminals 200 may comprise a given density per volume of the shell 210 as desired.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A push-button actuator used for releasing an external fiber optic connector from a connection port, the push-button actuator comprising:
a first piece having a first diameter and a second diameter with the first diameter being larger than the second diameter;
a second piece configured as an annular ring that cooperates with the first piece; and
a seal sized for fitting about the second diameter of the first piece.

2. The push-button actuator of claim 1, wherein a portion of the second piece fits about part of the first piece for defining a location between the first piece and the second piece for capturing the seal.

3. The push-button actuator of claim 1, wherein the second piece comprises a transmissive material that allow predetermined wavelengths to pass through the transmissive material for allowing welding of the second piece to the first piece.

4. The push-button actuator of claim 1, wherein the first piece comprises a finger protruding from a first side.

5. The push-button actuator of claim 4, wherein the finger comprises at least one groove configured for securing the second piece to the first piece.

6. The push-button actuator of claim 1, wherein the first piece comprises a polycarbonate material.

7. The push-button actuator of claim 1, wherein the push-button actuator is a portion of a fiber optic terminal comprising at least one connection port for receiving an external fiber optic connector.

8. The push-button actuator of claim 7, wherein the push-button actuator is configured for engaging a securing member of the fiber optic terminal associated with the at least one connection port for translating the securing member to an open position for releasing the external fiber optic connector from the connection port of the fiber optic terminal.

9. A push-button actuator used for releasing an external fiber optic connector from a connection port, the button actuator comprising:
a first piece having a first diameter and a second diameter with the first diameter being larger than the second diameter along with a finger protruding from a first side;
a second piece configured as an annular ring that cooperates with the first piece, wherein the second piece is welded to the first piece; and
a seal sized for fitting about the second diameter of the first piece.

10. The push-button actuator of claim 9, wherein a portion of the second piece fits about part of the first piece for defining a location between the first piece and the second piece for capturing the seal.

11. The push-button actuator of claim 9, wherein the second piece comprises a transmissive material that allow predetermined wavelengths to pass through the transmissive material for allowing welding of the second piece to the first piece.

12. The push-button actuator of claim 9, wherein the first piece comprises a finger protruding from a first side.

13. The push-button actuator of claim 12, wherein the finger comprises at least one groove configured for securing the second piece to the first piece.

14. The push-button actuator of claim 9, wherein the first piece comprises a polycarbonate material.

15. The push-button actuator of claim 9, wherein the push-button actuator is a portion of a fiber optic terminal comprising at least one connection port for receiving an external fiber optic connector.

16. The push-button actuator of claim 14, wherein the push-button actuator is configured for engaging a securing member of the fiber optic terminal associated with the at least one connection port for translating the securing member to an open position for releasing the external fiber optic connector from the connection port of the fiber optic terminal.

17. A fiber optic terminal for making an optical connection with one or more external fiber optic connectors, the fiber optic terminal comprising:
a shell;
at least one connection port disposed on the fiber optic terminal with the at least one connection port comprising an optical connector opening extending from an outer surface of the fiber optic terminal into a cavity of the fiber optic terminal and defining a connection port passageway;
at least one securing feature being associated with the connection port passageway;
at least one securing feature resilient member for biasing a portion of the at least one securing feature; and
a push-button actuator that cooperates with the at least one securing feature, the button actuator comprising a first piece having a first diameter and a second diameter and the first diameter being larger than the second diameter, and a second piece configured as an annular ring that cooperates with the first piece; and
a seal sized for fitting about the second diameter of the first piece.

18. The fiber optic terminal of claim 17, wherein the at least one securing feature is capable of translating.

19. The fiber optic terminal of claim 17, wherein of the at least one securing feature is biased to a retain position by the at least one securing feature resilient member.

20. The fiber optic terminal of claim 17, wherein a portion of the at least one securing feature is part of the modular adapter sub-assembly.

21. The fiber optic terminal of claim 17, wherein the at least one securing feature comprises a bore that is aligned with the at least one connection port passageway.

22. The fiber optic terminal of claim 17, wherein the at least one securing feature comprises further comprises a locking feature.

23. The fiber optic terminal of claim 22, wherein the locking feature comprises a retention surface.

24. The fiber optic terminal of claim 22, wherein the locking feature comprises a ramp with a ledge.

25. The fiber optic terminal of claim 17, wherein the at least one connection port is a portion of the shell.

26. The fiber optic terminal of claim 17, wherein the shell comprises at least a first portion and a second portion.

27. The fiber optic terminal of claim 17, further comprising an optical splitter disposed within a cavity of the shell.
